(19) United States
(12) Patent Application Publication
(10) Pub. No.: US 2014/0119608 A1
(43) Pub. Date: May 1, 2014

(54) System and Methods for Improving Accuracy and Robustness of Abnormal Behavior Detection

(71) Applicant: Panasonic Corporation, Osaka (JP)

(72) Inventors: Kuo Chu Lee, Princeton Junction, NJ (US); Hasan Timucin Ozdemir, Plainsboro, NJ (US); Juan Yu, Cranbury, NJ (US); Xiangjun Shi, Plainsboro, NJ (US)

(73) Assignee: Panasonic Corporation, Osaka (JP)

(21) Appl. No.: 14/150,131

(22) Filed: Jan. 8, 2014

Related U.S. Application Data
(62) Division of application No. 12/496,681, filed on Jul. 2, 2009.
(60) Provisional application No. 61/153,884, filed on Feb. 19, 2009.

(51) Int. Cl. G06T 7/20

(52) U.S. Cl. CPC G06T 7/20
USPC 382/103

(57) ABSTRACT

A surveillance system which improves accuracy and robustness of abnormal behavior detection of a monitored object traversing a space includes a metadata processing module, a model building module, and a behavior assessment module. The metadata processing module generates trajectory information for a monitored object and determines attributes of the monitored object. The model building module generates and updates normal motion models based on at least one of the trajectory information, the attributes, and an abnormal behavior score. The behavior assessment module generates the abnormal behavior score based on one of a plurality of methods. A first one of the plurality of methods defines wrong direction behavior. A second one of the plurality of methods defines wandering/loitering behavior. A third one of the plurality of methods defines speeding behavior.

### CROSS-REFERENCE TO RELATED APPLICATIONS

This application is a divisional of U.S. patent application Ser. No. 12/496,681, filed on Jul. 2, 2009, which claims the benefit of U.S. Provisional Application No. 61/153,884, filed on Feb. 19, 2009. The entire disclosures of the above applications are incorporated herein by reference.

### FIELD

The present disclosure relates to surveillance systems and, more particularly, to systems and methods for improving accuracy and robustness of automated abnormal behavior detection in video surveillance systems.

### BACKGROUND

Typical surveillance systems include a plurality of sensors that may collect data and/or monitor for security threats based on predetermined conditions. For example only, the plurality of sensors may include video cameras. Typical video surveillance systems may include a plurality of video cameras that monitor a large geographic area. For example only, the large geographic area may be a warehouse. Each of the plurality of video cameras may collect metadata corresponding to a monitored area. A human operator may be required to simultaneously monitor a plurality of video feeds from the plurality of video cameras, and thus some security threats may not be detected. Therefore, video surveillance systems may include automated detection systems that monitor areas based on predetermined conditions. For example, the predetermined conditions may be referred to as “normal activity patterns.” (see Crimson-1998: W. E. L. Crimson, Chris Stauffer, Lily Lee, Raquel Romano, “Using Adaptive Tracking to Classify and Monitor Activities in a Site”, Proceedings IEEE Conf. on Computer Vision and Pattern Recognition, pp. 22-31, 1998).

For example, the automated detection system may detect “abnormal motion patterns” based on the collected metadata and the normal motion patterns (see Crimson). In other words, the automatic detection system may alert the human operator of a potential security threat when abnormal behaviors are detected. The operator may analyze the potential security threat and choose whether to actuate an alarm. Additionally, the automatic detection system may actuate an alarm without notifying the operator. Furthermore, the automatic detection system may store metadata corresponding to the potential security threat for updating of the predetermined conditions and/or future analysis of the potential security threat.

For example only, U.S. Pat. No. 7,088,846 discloses a video surveillance system that uses rule-based reasoning and multiple-hypothesis scoring to detect predetermined object behavior based on object movement and events initiated by object. The system determines an alert condition based on the movement patterns of an object. The alert condition may be defined by an occurrence of a combination of particular events. For example only, the particular events may include an appearance of a person, a movement of the person towards a door, or the person swiping an object at a card reader. The system may determine whether the particular events have occurred and may determine a time stamp for each of the particular events. The system may then determine whether an alert condition has occurred based on predefined rules.

For example, U.S. Pat. No. 6,707,486 discloses an alarm system that automatically monitors activity and directional motion in a predetermined area. Specifically, the alarms may only be generated if the system detects movement in a particular direction greater than a predetermined threshold and/or if the moving object detected by the video camera is of a particular size. Alternatively, for example, U.S. patent application Ser. No. 11/676,127 “Surveillance System and Methods” discloses a surveillance system detecting abnormal local motion by utilizing online localized motion model estimation from metadata to remove numerous rule configurations.

However, the system may require that an entire rule set is to be configured by the operator. Furthermore, the system may require that the particular events are to be based on a particular sequence of the particular events. Thus, these requirements may make it difficult to completely define a model of abnormal behavior for a moderate-sized to large-sized rule set. Furthermore, the metadata obtained from video motion detection and tracking includes various errors due to, for example, light changes, sudden background changes, shadows, static occlusion, self occlusion, merging objects, splitting objects. For a camera with a perspective view, error may result due to the motion type, such as when an object moves from a far-field to the camera or from the camera to the far-field, etc. Object location errors may be compensated for using, for example, Kalman filters with predefined motion models. When the motion of object is assessed for abnormal behavior detection, accurate location information is important to prevent false alarms that would be detrimental to the objective of the system.

To remedy these potential inaccurate location readings, the abnormal behavior detection system should support robust abnormal motion detection. The robust tracking may include two levels of error handling: one for estimated tracking error and one for the camera to capture position detection errors in different parts of camera view, such as far-field and near-field position, where detection errors may be different. Using prior error distributions as feedback with current error patterns may provide for dynamic adjustment of measurement windows to produce more accurate and robust estimation of velocities of moving objects. Additionally, a sampling window and an algorithm for determination of velocity, speed, and acceleration of moving object may be adjusted based on the above position detection errors.

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

A method for determining abnormal behavior of an object traversing a space includes receiving trajectory information for an object whose movement in the space is being monitored, where the trajectory information indicates a current position of the monitored object, retrieving a trajectory model that corresponds to the current position of the monitored object, where the trajectory model defines possible directions that an object at the current position may travel and, for each possible direction, a likelihood that the object at the current position would travel in the corresponding possible direction, computing a likelihood that the monitored object is traveling in a direction based on a weighted average of likelihoods for two or more of the possible directions given by the model, where the two or more possible directions are those nearest to the direction of the monitored object, and identifying abnormal behavior of the monitored object based on the computed likelihood.

A method for determining abnormal behavior of an object traversing a space includes receiving trajectory information for an object whose movement in the space is being monitored, where the trajectory information indicates a current position of the monitored object and distances that the monitored object has traveled from the current position during a previous time period, retrieving a trajectory model that corresponds to the current position of the monitored object, where the trajectory model defines a threshold distance that an object at the current position would have traveled from the current position during the previous time period, comparing the distances to the threshold distance, and identifying abnormal behavior of the monitored object based on the comparison.

A method for determining abnormal behavior of an object traversing a space includes receiving trajectory information for an object whose movement in the space is being monitored, where the trajectory information indicates a current position of the monitored object, a direction that the monitored object is traveling, and a velocity of the monitored object, retrieving a trajectory model that corresponds to the current position of the monitored object, where the trajectory model defines possible directions that an object at the current position may travel and, for each possible direction, a velocity at which the object at the current position would travel, computing a velocity threshold for the monitored object based on a weighted average of the velocities for two or more of the possible directions given by the model, where the two or more possible directions are those nearest to the direction of the monitored object, and identifying abnormal behavior of the monitored object based on the velocity of the monitored object and the computed velocity threshold.

A surveillance system that improves accuracy and robustness of abnormal behavior detection of a monitored object traversing a space includes a metadata processing module, a model building module, and a behavior assessment module. The metadata processing module generates trajectory information corresponding to the monitored object and that determines attributes of the monitored object based on at least one of a plurality of normal motion models and a dynamic time window, wherein the attributes include an estimated velocity of the monitored object, whether the monitored object is an outlier, and a measurement error estimation. The model building module at least one of generates and updates the plurality of normal motion models based on at least one of the attributes of the monitored object and an abnormality score corresponding to the monitored object. The behavior assessment module generates the abnormal behavior score corresponding to the monitored object based on one of a plurality of abnormal behavior detection methods.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of a surveillance system according to the present disclosure;

FIGS. 2A and 2B are schematics illustrating exemplary fields of view of exemplary sensing devices according to the present disclosure;

FIG. 3 is a functional block diagram of an abnormal behavior detection module according to the present disclosure;

FIG. 4 is a flow diagram of a method of processing metadata according to the present disclosure;

FIG. 5 is a functional block diagram of a model building module according to the present disclosure;

FIG. 6 is a functional block diagram of a behavior assessment module according to the present disclosure;

FIGS. 7A and 7B are graphical representations of exemplary directions and corresponding likelihoods and angle differences between exemplary directions and an exemplary direction of a monitored object;

FIG. 8A is a flow diagram of a method of detecting wrong direction behavior according to the present disclosure;

FIG. 8B is a flow diagram of a method of detecting wandering behavior according to the present disclosure;

FIG. 8C is a flow diagram of a method of detecting speeding behavior according to the present disclosure; and

FIG. 9 is a flow diagram of a method of operating the surveillance system according to the present disclosure.

Corresponding reference numerals indicate corresponding parts throughout the several views of the drawings.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logic. It should be understood that steps within a method may be executed in different order without altering the principles of the present disclosure.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Typical systems and methods used to detect abnormal motion behavior may be limited by several factors. More specifically, a substantial amount of the work in video analytics has been focused on collecting motion data in user-specified “regions of interest” (ROIs). The collected motion data may then be compared to motion data for an input object using user-specified thresholds. In other words, the motion trajectory of the monitored object may be compared with motion patterns and distance threshold defined by user to detect these motion patterns. For example, one limiting factor may be a difficulty associated with the user setting and keeping track of ROIs and thresholds for all areas. For example, another limiting factor may be dynamically changing behavior of the input object. Furthermore, another limiting factor may be unpredictable occlusion and lighting conditions in an area with non-uniform geographical surfaces.

A large amount of work may be required to transform two-dimensional (2D) video motion of an object to three-dimensional (3D) physical trajectories. More specifically, a substantial camera calibration and actual measurement of physical geometry in the 2D projected view may be required. Both camera calibration and actual measurement of physical geometry may be difficult for security operators and thus both may be prone to multiple types of errors. For example, lighting and occlusion may cause errors in measuring the actual position, size, and/or depth of the monitored objects. Next, for example, when a ground plane is not flat the velocity of the monitored object may appear to be moving at a different velocity than the actual velocity. Additionally, for example, resolution of a location of the monitored object and the velocity measurement may be affected by an angle of camera and the motion direction of the monitored object, such as the monitored object moving away from or towards the camera. Lastly, for example, the position errors corresponding to different locations in the camera field of view may change over time.

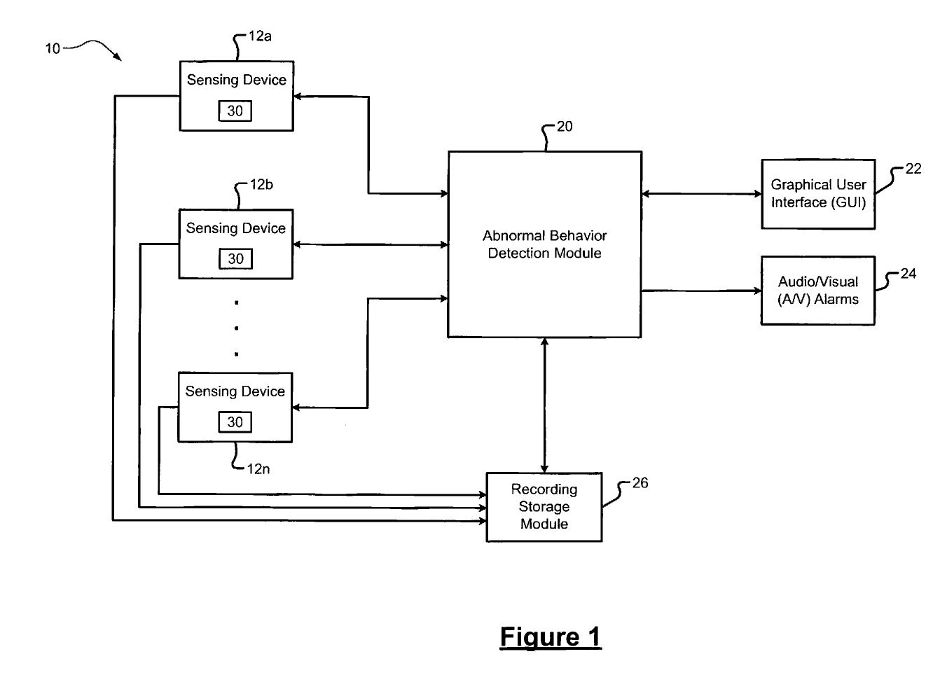

Referring to FIG. 1, an exemplary video surveillance system 10 is shown. The system includes sensing devices 12a-12n, an abnormal behavior detection module 20, a graphical user interface (GUI) 22, audio/visual (A/V) alarms 24, and a recording storage module 26. Sensing devices 12a-12n record motion or image data relating to objects. Sensing devices 12a-12n may each include a metadata generation module 30. For example, the metadata generation module 30 may generate metadata based on the recorded motion of objects according to methods well-known in the art. While it is shown that each of the sensing devices 12a-12n includes a metadata generation module 30, the video surveillance system 10 may include an external metadata generation module 30 (i.e., on a shared network). Furthermore, the abnormal behavior detection module 20 may also include the metadata generation module 30.

The sensing devices 12a-12n communicate the metadata to abnormal behavior detection module 20. The abnormal behavior detection module 20 may analyze behavior of the objects based on the received metadata. The abnormal behavior detection module 20 may also generate an alarm message for at least one of the GUI 22, the A/V alarms 24, and the recording storage module 24. For example, the received metadata may include, but is not limited to a camera identifier, a field of view identifier, an object identifier, a time stamp, and/or location of an object in the field of view. The location of the object may be described by a rectangle which encloses the area (in the image) occupied by monitored object. This rectangle may be referred to as a “minimum bounding box (MBB)” or “minimum bounding rectangle (MBR).” The rectangle may be specified by coordinates of an upper-left corner of the rectangle, a width of the rectangle, and a height of the rectangle. The location of the object may be identified by a binary mask which is defined in the MBR and denotes which pixels are occupied by the monitored object. The metadata may further include an original image of the monitored object and/or other appearance features representative of the monitored object such as color, shape, object type, merge/split events of the monitored object, etc.

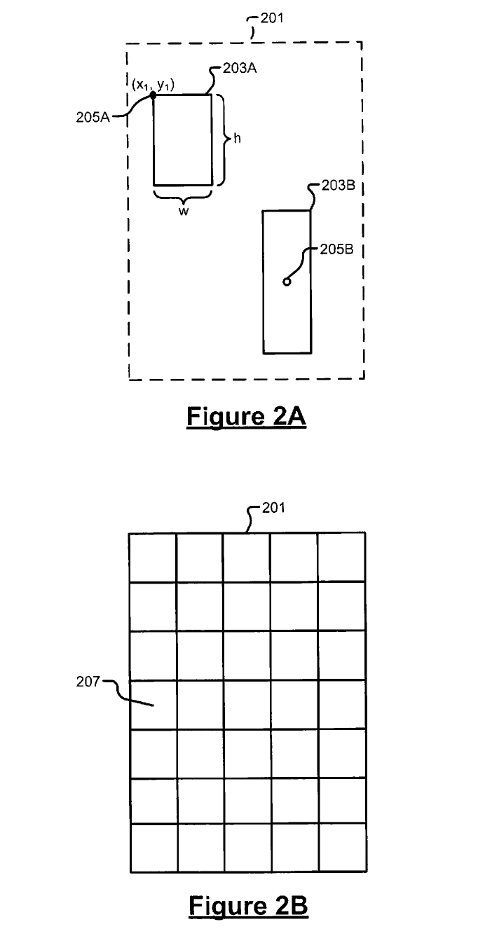

In one embodiment, the sensing devices 12a-12n may be video cameras or other devices that may capture motion, such as an infrared camera, a thermal camera, a sonar device, or a motion sensor. The sensing devices 12a-12n are configured to record motion with respect to a target area or a grid within the field of view of the device. For exemplary purposes only, a target area and a grid are shown in FIGS. 2A-2B and described in greater detail below.

Referring now to FIG. 2A, an exemplary field of view 201 of one of the sensing devices 12a-12n is shown. The field of view 201 includes multiple target areas 203A and 203B. Target area 203A includes an upper-left corner point 205A located at (x1,y1), a height h, and/or a width w. Thus, a center of target area 203A may be derived from point (x1,y1), the height h, and the width w. Furthermore, target area 203B includes additional information such as a camera ID number, a field of view ID number, a target ID number, and/or a name of a target area (e.g., break room door). For example, target area 203B may be a door and area 205B may be a handle of the door.

It can be appreciated that additional information relevant to the target area may also be stored. It can be appreciated that other shapes may be used to describe the target area, such as an ellipse, a circle, etc. Target area information may be stored in a table. An exemplary table for storing target area definitions is provided below:

| | | | | | | | |
|---|---|---|---|---|---|---|---|
| Camera | Field of View | Target Area | | | | | Target |
| ID # | ID # | ID # | x | y | w | h | Name |

FIG. 2B illustrates another exemplary field of view 201 of one of the sensing devices 12a-12n. Field of view 201 includes a grid 207 interposed on the field of view 201 of the sensing devices 12a-12n. Thus, the position of an object at a given time may be defined by the position of the object with respect to the grid 207. For example, when grid 207 is used, data relating to the location or motion of an object may be stored in a data structure known as a data cube. In one embodiment, a data cube may be a data structure of three or more dimensions that includes information that may be used to describe a time series of image data, such as (x-value, y-value, time stamp). For example, a data cube may include normal motion models for each cell of a grid. In the grid, the camera field of view may be decomposed into cells and observations (e.g., motion of monitored object) in each cell may be used to update the normal motion model in this cell. The models capture statistics of observed object properties, such as expected direction and magnitude of velocity and its standard deviation, etc. The third dimension may be added for inclusion of time intervals to represent that the site usage depends on time (i.e., time-based modeling). For example, the motion behavior of monitored objects may change depending on morning hour, lunch time, afternoon, night, weekend, etc.

The collection of data cubes may be referred to as a trajectory model. Trajectory models may hereinafter be referred to as normal motion models. Thus, in an exemplary embodiment, each data cube in a normal motion data model is a location with respect to a target area and a time stamp. It can be appreciated that each data cube may contain additional information, such as a z-value, color information, and/or object identifying tags.

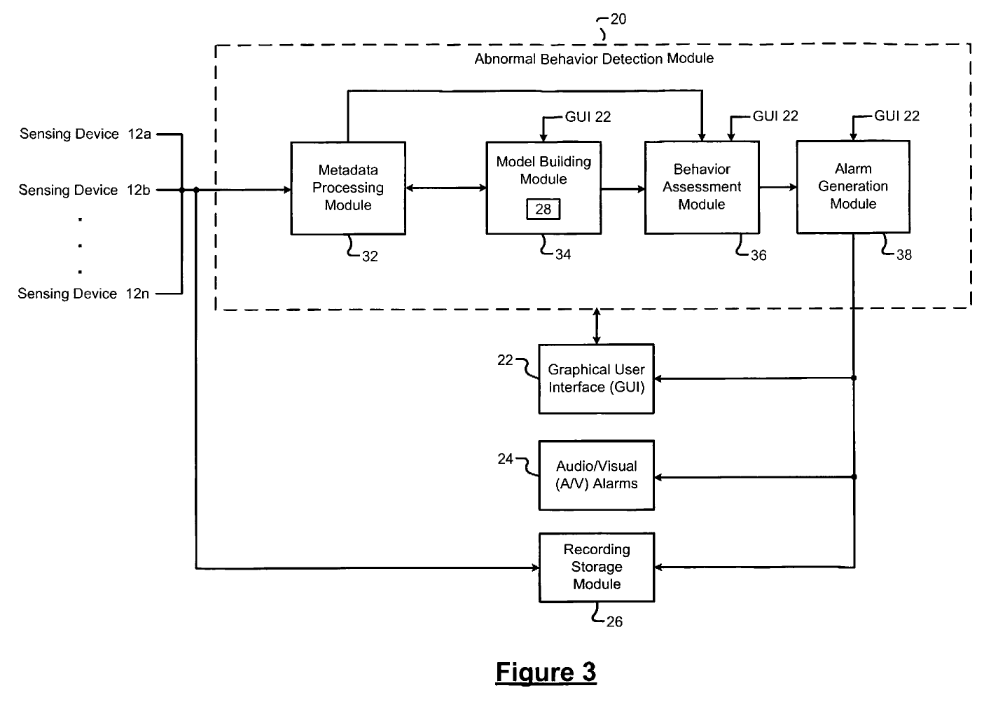

Referring now to FIG. 3, exemplary abnormal behavior detection module 20 is shown in more detail. Exemplary abnormal behavior detection module 20 includes a metadata processing module 32, a model building module 34, a behavior assessment module 36, and an alarm generation module 38. It is understood that the modules described may be combined into a single module, or may include multiple sub-modules.

Exemplary metadata processing module 32 receives the metadata from sensing devices 12a-12n and stores the metadata in a datastore. For example, the metadata may include, but is not limited to, a video camera identifier, an object identifier, a time stamp, an x-value, a y-value, an object width value, and an object height value. In one embodiment, the metadata processing module 32 may determine whether a detected position of object is an outlier and then may generate additional metadata corresponding to the monitored object if the detected position of object is an outlier. For example, the metadata processing module 32 may use techniques known in the art to determine whether the detected position of object is classified as an outlier based on received metadata.

The metadata processing module 32 may also receive feedback from the model building module 34 corresponding to data cubes. For example, the feedback may include a likelihood of estimation error of linear predictors (such as Kalman filter, AR) of an input trajectory of a set of objects in M×N cells of data cube with multiple time windows. Alternatively, the feedback may include expected statistics of object attributes that are observed from a set of normal object trajectories. For example, (k*sigma) may be used for determination of threshold for each object attribute (tie it to statistic interpretation of normal distribution). These statistics may then be recorded in M×N cells of data cube with multiple time windows.

Metadata processing module 32 generates trajectories for monitored objects. Additionally, the metadata processing module 32 may process the metadata into object attributes and store the object attributes in a datastore. For example, processing module 32 may use techniques known in the art for processing the metadata to obtain derived attributes from the metadata. In one embodiment, the object attributes may include an estimated velocity and motion direction, likelihoods (i.e., probabilities) corresponding to randomness of motion, and an estimated measurement error of the monitored object. Alternatively, exemplary object attributes may include (but are not limited to):
a trajectory duration (e.g., a time period that the monitored object is moving in an ROI);
a trajectory boundary area for the monitored object;
a predicted position of the monitored object (e.g., via a Kalman filter);
a log-likelihood based on the predicted position;
an estimated position measurement error;
a change in motion direction;
an outlier indicator and an outlier type for the monitored object (i.e., abnormality beyond a threshold);
a velocity and a direction;
an estimated position (e.g., for updating normal behavior models)
a level of motion randomness (i.e., a rate of change of motion direction);
a normalized velocity (e.g., a ratio between velocity and the estimated velocity from a normal behavior model, used to compensate for differences in far-field and near-field area of camera view, retrieved from data cube corresponding to a normal behavior model); and/or
a normalized object size (e.g., a ratio of object size over the average object size from a normal behavior model).

The estimated velocity, the direction, and the normalized speed may be used to reduce “false-negatives” (i.e., incorrect normal behavior detection). Additionally, the outlier indicator, the change in motion direction, and level of randomness may be used to reduce “false-positives” (i.e., incorrect abnormal behavior detection). More specifically, if the outlier indicator indicates that the monitored object is an outlier, the monitored object (and its corresponding attributes) may not be used to update the normal behavior models.

The metadata processing module 32 may determine that the current position of the monitored object is an outlier in one of four ways. More specifically, observation i is marked as an outlier based on combination of the following methods for the monitored object (e.g., ts(i),x(i),y(i),w(i),h(i)).

First, a sudden change in size and/or shape may result in the current position of the monitored object being marked as an outlier. For example, the change may be determined as follows:

Change=|MBR(i).w−MBR(i−1).w|+|MBR(i).h−MBR(i−1).h|,

where MBR(i).w and MBR(i−1).w represent widths of the monitored object at observations i and (i−1), respectively, and where MBR(i).h and MBR(i−1).h represent heights of the monitored object at observations i and (i−1), respectively. When the change exceeds a predetermined change threshold, the monitored object may be marked as an outlier.

Second, a sudden change in a size ratio r(i) of the monitored object may result in the current position of the monitored object being marked as an outlier. For example, the size ratio r(i) may be determined as follows:

$$r ( i ) = \frac{NumofPixels ( i )}{MBR ( i ) . w \times MBR ( i ) . h} ,$$

where NumofPixels(i) represents a pixel size of the monitored object at observation i. When the size ratio r(i) exceeds a predetermined size ratio threshold, the monitored object may be marked as an outlier.

Third, a sudden change in velocity and/or acceleration of the monitored object may result in the current position of the monitored object being marked as an outlier. In other words, for example, when the velocity and/or the acceleration of the monitored object exceeds predetermined velocity and/or acceleration thresholds, the monitored object may be marked as an outlier.

Lastly, a sudden change in a product of direction and velocity of the monitored object may result in the current position of the monitored object being marked as an outlier. In other words, for example, when the product of the direction and velocity of the monitored object exceeds a predetermined product threshold, the monitored object may be marked as an outlier. For example, the product threshold may be based on combination of a likelihood of estimation error of linear predictors (such as Kalman filter, AR) of input trajectory of set of objects in M×N cells of data cube with multiple time windows, expected statistics of object attributes that are observed from a set of normal object trajectories. For example, (k*sigma) may used for determination of threshold for each object attribute (i.e., relate it to a statistic interpretation of the normal distribution). Thus, these statistics may then be recorded in M×N cells of a data cube with multiple time windows.

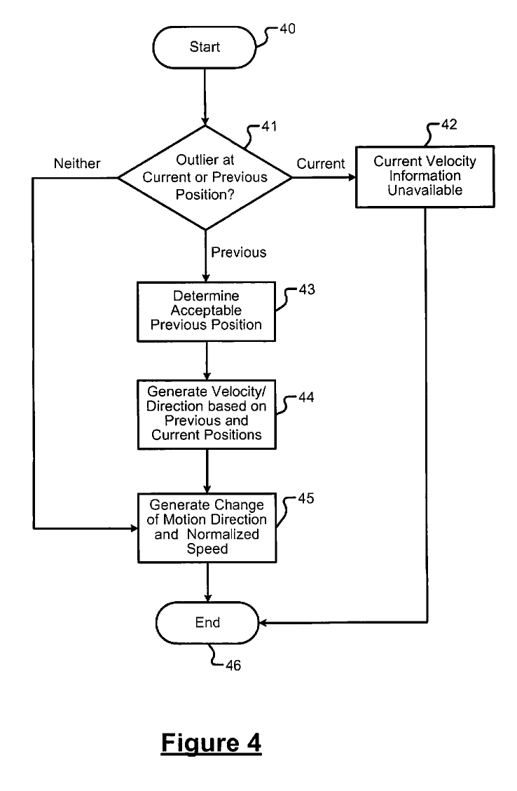

Referring now to FIG. 4, a flow diagram illustrating one embodiment of processing the metadata by the metadata processing module 32 begins in step 40. In step 41, the metadata processing module 32 determines whether the current or past positions of the monitored object is (or was) an outlier at a current position (or a previous position). If the current position of the monitored object is an outlier at the current position, control proceeds to step 42. If the monitored object is an outlier at the previous position, control proceeds to step 43. If the monitored object is not an outlier at the current or previous positions, then control proceeds to step 45.

In step 42, no current velocity information exists since the current position is an outlier, and control may end in step 46. In other words, the normal motion models do not include velocity information corresponding to outliers (i.e., outliers are filtered out). The metadata processing module 32 may implement an outlier handling function in order to adapt to increases in the minimal displacement necessary for obtaining accurate attributes such as velocity and acceleration. The outlier handling function may also accumulate more properties from objects to determine possible causes of the objects being marked as outliers. For example, for an outlier that is marked by mistaking the object for a different object, the outlier handling function may output an indicator (i.e., the outlier indicator) to prevent miscalculation of the attributes from the original tracked objects. Thus, if the outlier handling function detects a same object based on the object attributes, the outlier handling function may mark the outlier position which is indicative of a larger minimal displacement and thus more sample points needed to calculate the attributes of the monitored object.

In step 43, the metadata processing module 32 determines an acceptable previous position to be used. More specifically, the metadata processing module 32 may determine a previous position when the monitored object was a predetermined distance (i.e., a minimum distance) from the current position. In step 44, the metadata processing module 32 generates velocity and/or direction of the monitored object based on the acceptable previous position, the current position, and a corresponding period of time. In step 45, the metadata processing module 32 may generate a change in motion direction and a normalized speed based on the acceptable previous position of the monitored object. In one embodiment, if the minimal displacement distance cannot be determined in the trajectory of the monitored object, then the velocity may not be calculated, and an error type may be denoted at the output.

The minimal displacement distance may be used to accommodate for outliers and other normal tracking errors. For example, for an outlier, the minimal displacement may be set to be twice the magnitude of distance (i.e., jump) of the outlier. Thus, the velocity calculation may adapt to a lower resolution and provide low confidence for the points within the minimal displacement set from the center of the jump caused by the outlier. Control may then end in step 46. Furthermore, the minimal displacement may also be adjusted based on a size variation of the objects, quantization error of far field observation in the camera, direction of movement, and minimal number of samples to confirm the likelihood of the position of the moving objects.

Referring back to FIG. 3, model building module 34 receives object attributes from the metadata processing module 32. The model building module 34 builds normal motion models and stores the normal motion models in a normal model datastore 28. The model building module 34 may also update existing normal data models in the normal model datastore 28 based on the object attributes. For example, the module building module 34 may disregard metadata of the monitored object if the observation is marked as outlier while updating normal motion models in data cube.

The normal motion models correspond to expected motion of objects or “safe” motion behavior of an object. For example, in a workplace environment, a normal motion model may capture an employee walking at a safe speed from a work area to a break room. Conversely, an employee walking through a restricted area or a safety hazard zone may constitute an unsafe behavior or movement and thus may not be included in a normal motion model. For example, a data cube may include normal motion models in each cell of a grid. In the grid, the camera field of view may be decomposed into cells, and observations (motion of monitored object) in each cell may be used to update the normal motion model in this cell. The models capture statistics of observed object properties, such as expected direction and magnitude of velocity and its standard deviation, etc. The third dimension may be added for inclusion of time intervals to represent that the site usage depends on time. Additionally, the motion behavior of monitored objects may change depending on morning hour, lunch time, afternoon, night, weekend, etc.

Behavior assessment module 36 retrieves normal motion models from the normal model datastore 28 and processes received metadata based on the normal motion models. In other words, the behavior assessment module 36 analyzes the received metadata corresponding to the monitored object and determines whether the monitored object is acting in conformity with the normal motion models.

The behavior assessment module 36 may generate abnormality scores corresponding to the monitored object. The abnormality scores are generated according to abnormal behavior models that compute differences between the normal motion models and metadata corresponding to the monitored object. The abnormal behavior models may include a wrong direction model, a wandering (i.e., loitering) model, and a speeding model.

The alarm generation module 38 activates at least one device when the abnormality scores exceed a threshold that corresponds to normal (i.e., acceptable) behavior. The devices may be the GUI 22, the A/V alarms 24, and/or the recording storage module 26. Furthermore, an alarm may be sent to additional devices and/or parties, such as a nearby police station (to request assistance) or to a machine (to cut power in order to prevent injury to an operator).

The GUI 22 may display a notification on a screen to draw attention of a security guard or other user. The guard may then watch the object to determine whether any further action should be taken, such as activating the A/V alarms 24. However, the security guard may also classify the trajectory of the monitored object as normal behavior via the GUI 22, after which the corresponding metadata may be stored in the normal model datastore 28.

The A/V alarms 24 may include lights and/or sirens attached to walls, floors, vehicles, cameras, and/or wireless portable devices carried by employees. Different A/V alarms 24 may be activated based on the abnormality score. For example, when the abnormality score is below a threshold, a light may flash, but when the score is above the threshold, multiple lights may flash and the sirens may sound indicating the severity level of abnormal behavior.

The recording storage module 26 begins recording image data and/or metadata from sensor devices 12a-12n when activated. Thus, the recording storage module 26 allows the system 10 to capture and record all abnormal behaviors without requiring the system 10 to constantly record and/or store irrelevant data.

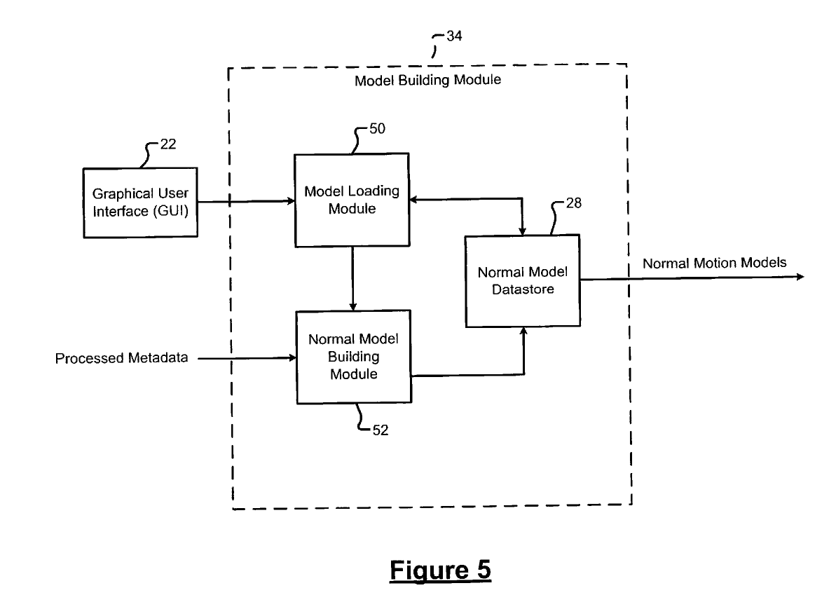

Referring now to FIG. 5, the model building module 34 is shown in more detail. Model building module 34 includes a model loading module 50, a normal model building module 52, and the normal model datastore 28. The model building module 34 operates in one of two modes: learning and operational. The model building module 34 may switch from learning mode to operational mode after a certain amount of samples are collected or a user initiates the switch over. Additionally, the user may control whether the model adaptation continues after switching to operational mode dynamically (i.e., automatically).

In learning mode, the normal model building module 52 builds a normal motion model based on received metadata and stores the normal motion model in the normal model datastore 28. The normal model building module 52 may also update existing normal motion models in the normal model datastore 28 with the received metadata. Furthermore, metadata, parameters, and/or entire models may be loaded into the normal model building module 52 by an operator via the GUI 22 and the model loading module 50.

In operational mode, the behavior assessment module 36 retrieves normal motion models stored in the normal model datastore 28 for behavior assessment of a monitored object. After behavior assessment and/or alarm activation is complete, the model building module 34 updates the existing normal motion models in the normal motion model database (as described above).

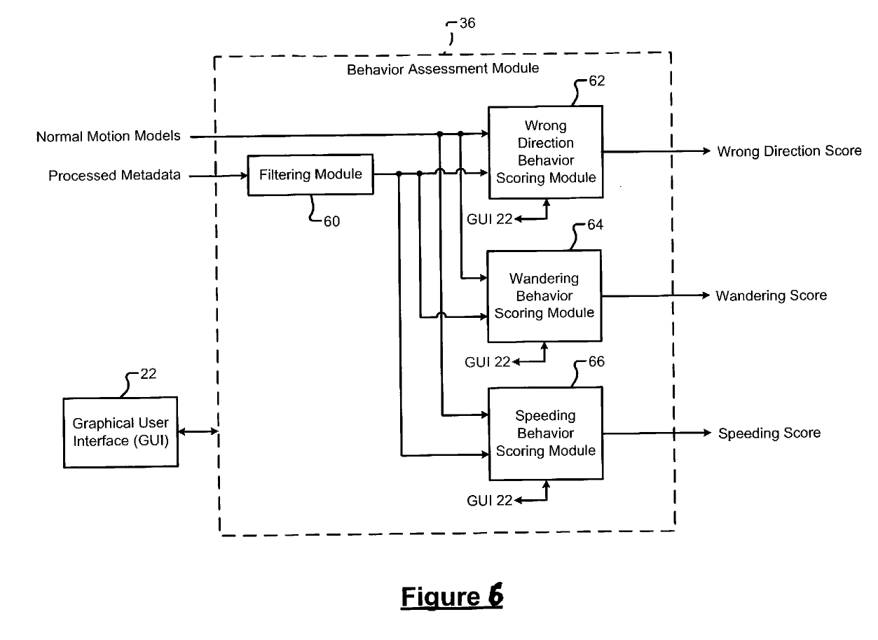

Referring now to FIG. 6, the behavior assessment module 36 is shown in more detail. The behavior assessment module 36 receives metadata corresponding to a monitored object. The behavior assessment module 36 also retrieves normal motion models from the normal model datastore 28. The behavior assessment module 36 processes the metadata and determines whether the monitored object is behaving abnormally (i.e., not in accordance with the normal motion models).

The behavior assessment module 36 includes a filtering module 60, a wrong direction behavior scoring module 62, a wandering behavior scoring module 64, and a speeding behavior scoring module 66. The filtering module 60 filters the metadata corresponding to the monitored object.

In one embodiment, the filtering module 60 may generate the outlier handling function output. For example, the outlier handling function output may include an outlier marking, a type of outlier, object properties, and a data cube that may be shared by scoring modules by open-interface with outside modules.

In another embodiment, the filtering module 60 may determine a minimum distance that the monitored object must travel. For example, the minimum distance may correspond to a noise level associated with one of the sensing devices 12a-12n. In other words, the minimum distance may be insufficient for generation of velocity information.

Additionally, the filtering module 60 may estimate an error of the position of the monitored object. Thus, the filtering module 60 may prevent false alarms due to incorrect abnormality scores. An M×N matrix model may be implemented by the filtering module 60 and is described in more detail below.

As previously described in FIG. 2B, the field of view 201 of one of the sensing devices 12a-12n is divided into cells 207. In other words, the M×N matrix model corresponds to M×N cells of a field of view of one of the sensing devices 12a-12n. Each of the M×N cells includes error information that may be used by the filtering module 60. For example, each of the M×N cells may include an average x-axis position error (aveXErr), a standard deviation of the x-axis position error (aveXErrStd), an average y-axis position error (aveYErr), a standard deviation of the y-axis position error (aveYErrStd), a number of x-axis samples (nx), and a number of y-axis samples (ny).

A position error model for each of the M×N cells may be generated as follows. First, original trajectories are defined by x-axis and y-axis positions corresponding to a time stamp (e.g., x, y, ts). The trajectories are then smoothed by a filter, such as a Kalman filter. Next, differences between the smoothed trajectories and the original trajectories are generated. In other words, the filtering module 60 generates for each trajectory an absolute value of a difference between a smoothed x-axis position xs(i) and an original x-axis position x(i) (e.g., εₓ(i)=|xs(i)−x(i)|) and an absolute value of a difference between a smoothed y-axis position ys(i) and an original y-axis position y(i) (e.g., ε_{y}(i)=|ys(i)−y(i)|).

After generating the differences, the filtering module 60 updates the position error model for the corresponding one of the M×N cells. The average x-axis position error may be updated based on the following:

$$aveXErr ( {n}_{x} + 1 ) = \frac{aveXErr ( {n}_{x} ) * {n}_{x} + {ɛ}_{x} ( i )}{{n}_{x} + 1} ,$$

where nₓ is a number of x-axis samples.

The standard deviation of the x-axis position error may be updated based on the following:

$$aveXErrStd ( {n}_{x} + 1 ) = \frac{( {n}_{x} - 1 ) * {( aveXErrStd ( {n}_{x} ) )}^{2}}{{n}_{x}} + \frac{( {n}_{x} + 1 ) * {( aveXErr ( {n}_{x} + 1 ) )}^{2}}{{( {n}_{x} )}^{2}} .$$

The average y-axis position error may be updated based on the following:

$$aveYErr ( {n}_{y} + 1 ) = \frac{aveYErr ( {n}_{y} ) * {n}_{y} + {ɛ}_{y} ( i )}{{n}_{y} + 1} ,$$

where n_{y} is a number of y-axis samples.

The standard deviation of the y-axis position error may be updated based on the following:

$$aveYErrStd ( {n}_{y} + 1 ) = \frac{( {n}_{y} - 1 ) * {( aveYErrStd ( {n}_{y} ) )}^{2}}{{n}_{y}} + \frac{( {n}_{y} + 1 ) * {( aveYErr ( {n}_{y} + 1 ) )}^{2}}{{( {n}_{y} )}^{2}}$$

Lastly, nₓ and n_{y} may be incremented by one. The updated position error models are used by the filtering module 60 to correct errors in the received metadata. The filtering module 60 then outputs the filtered metadata to datastores or other modules.

### Wrong Direction Behavior Scoring

The wrong direction behavior scoring module 62 processes metadata corresponding to a monitored object to determine whether the monitored object is traveling in a normal (i.e., safe) direction defined by the normal motion models.

The wrong direction behavior scoring module 62 retrieves normal motion models from the normal motion model database and retrieves the filtered metadata from the filtering module 60 (or a corresponding datastore). The wrong direction behavior scoring module 62 generates an abnormality score when the monitored object is traveling in an incorrect direction, described in more detail below.

The wrong direction behavior scoring module 62 creates and maintains likelihoods that an object at a particular position is traveling in particular directions. For example, the wrong direction behavior scoring module 62 may create and maintain likelihoods that an object is traveling in one of eight directional areas. In other words, for example only, each of the directional areas may correspond to 45 degrees each. An exemplary normal behavior (i.e., trajectory model) is shown below:

| Area | Direction | Vx | Stdx | Vy | Stdy | Count |
|---|---|---|---|---|---|---|
| 1 | 0°-45° | | | | | |
| 2 | 45°-90° | | | | | |
| 3 | 90°-135° | | | | | |
| 4 | 135°-180° | | | | | |
| 5 | 180°-225° | | | | | |
| 6 | 225°-270° | | | | | |
| 7 | 270°-315° | | | | | |
| 8 | 315°-360°/0° | | | | | |

Area corresponds to the directional area (i.e., 45 degree section), Vx corresponds to an expected velocity in the x-direction, Stdx corresponds to a standard deviation of Vx in the corresponding Area, Vy corresponds to an expected velocity in the y-direction, Stdy corresponds to a standard deviation of Vy in the corresponding Area, and Count corresponds to a number of samples in the corresponding Area.

In other words, Vx and Vy correspond to a most likely direction within the corresponding Area. Additionally, Count relates to the likelihood (i.e., probability) that an object at the corresponding position would travel in a direction corresponding to the Area compared to a total number of samples (i.e., total of Count column, or Count_total).

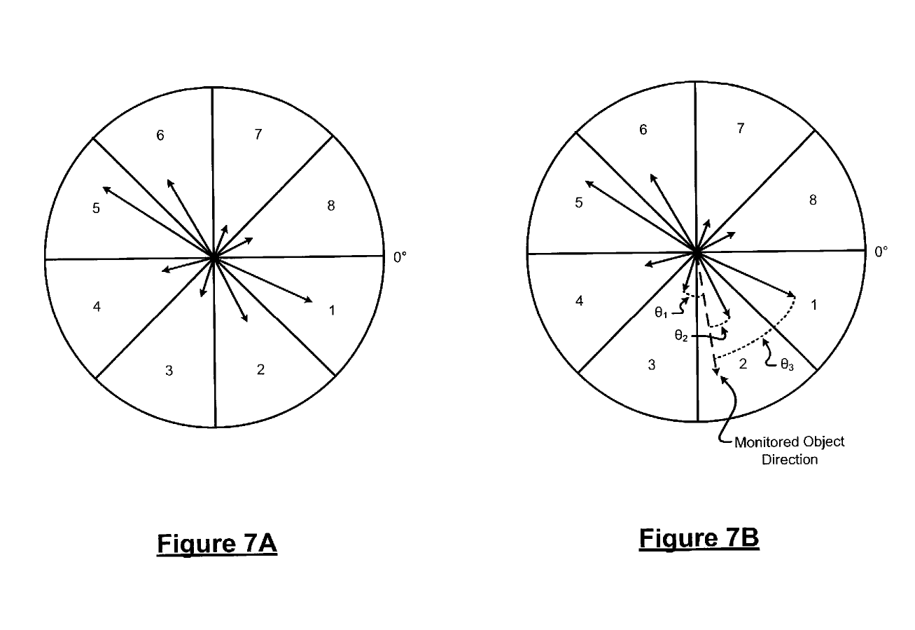

Referring now to FIGS. 7A and 7B, graphical representations of the table of likelihoods (above) are shown. FIG. 7A illustrates a most likely direction that an object would travel for each of the eight quadrants. Furthermore, a longer arrow in a quadrant corresponds to a higher likelihood that an object would travel in a direction corresponding to that quadrant.

Referring to FIGS. 6 and 7B, the wrong direction behavior scoring module 62 determines a direction of a monitored object based on the received metadata corresponding to the monitored object. The wrong direction behavior scoring module 62 then determines K closest directions to the determined direction of the monitored object. K may be predetermined or may be set by an operator via the GUI 22. For example, K may be three, as illustrated in FIG. 7B. The K=3 closest directions correspond to the smallest angles (θ) between the directions and the direction of the monitored object. As shown in FIG. 7B, the three smallest angles may be θ₁, θ₂, and θ₃.

The wrong direction behavior scoring module 62 generates an abnormal behavior score based on the direction of the monitored object, the K closest directions, and their corresponding likelihoods. The wrong direction behavior scoring module 62 may generate a weighted average of the K closest directions as follows:

$$L\_final = \frac{{\sum }_{j = 1}^{K} {L}_{j} * cos ( {θ}_{j} )}{{\sum }_{j = 1}^{K} cos ( {θ}_{j} )}$$

where Lⱼ corresponds to (Count/Count_total) of the corresponding θⱼ which corresponds to the angle between a directional angle of the monitored object and a directional angle of one of the K closest directions.

The wrong direction behavior scoring module 62 then generates raw abnormality scores as follows:

$$Score\_raw ( t ) = exp ( - \frac{L\_mean}{L\_final} )$$

where L_mean is an average likelihood of all directions in the corresponding region.

In other words, the score is close to zero when the monitored object is traveling in the correct (i.e., the most likely) direction. The raw scores (Score_raw) may be averaged over multiple time windows to determine an average wrong direction abnormality score over a period of time.

### Wandering Behavior Scoring

The wandering behavior scoring module 64 processes metadata corresponding to a monitored object to determine whether the monitored object is traveling a normal (i.e., safe) total distance during a period of time, defined by the normal motion models.

The wandering behavior scoring module 64 retrieves the normal motion models and the filtered metadata from the filtering module 60 (or a corresponding datastore). The wandering behavior scoring module 64 may generate an abnormality score when the monitored object is wandering (i.e., loitering) according to two different methods. First, the wandering behavior scoring module may generate an abnormality score when the monitored object is wandering within a predetermined area for a predetermined number of samples as described below.

### Number of Samples (Constant Sampling Rate)

First, the wandering behavior scoring module 64 generates an expected minimum trajectory length (expectedLen) based on an average length (aveLen) and a standard deviation of the average length (stdLen) corresponding to the trajectory. The expected minimum trajectory length expectedLen may be a sum of the average length aveLen and the standard deviation stdLen (expectedLen=aveLen+stdLen). In other words, the expected minimum trajectory length expectedLen may correspond to a minimum length of travel that defines wandering (i.e., loitering) behavior.

Next, the wandering behavior scoring module 64 generates an average speed (aveSpeed) of the monitored object based on the filtered metadata. The wandering behavior scoring module 64 then determines a number of samples (expectedNumofPoints) that correspond to wandering (i.e., loitering) behavior. The number of samples expectedNumofPoints may be one-third of the expected trajectory length expectedLen (expectedNumofPoints=expectedLen/3). The number of samples expectedNumofPoints may also be dynamically adjusted to counteract effects of objects in a far field of one of the sensing devices 12a-12n. In other words, an object in the far field may appear to be moving at a lower velocity than a corresponding actual velocity.

Next, the wandering behavior scoring module 64 determines a width of a square wandering area (width) based on the average speed of the monitored object aveSpeed and the number of samples expectedNumofPoints. The width may be a product of the average speed aveSpeed and the number of samples expectedNumofPoints (width=aveSpeed*expectedNumofPoints).

The wandering behavior scoring module 64 then counts a number of detected samples (NumofPoints) of the monitored object within the square wandering area, where the square wandering area is centered at the current position of the monitored object.

Finally, the wandering behavior scoring module 64 generates an abnormality score based on the number of detected samples NumofPoints and the expected number of samples expectedNumofPoints. The wandering behavior scoring module 64 may generate an abnormality score as follows:

$$Score = \{ \begin{matrix}1 - {e}^{( - ( NumofPoints - expectedNumofPoints ) / expectedNumofPoints )} \\ 0\end{matrix}$$

where Score equals zero when the detected number of samples NumofPoints is greater than or equal to both the expected number of samples expectedNumofPoints and zero.

### Time-Based (Non-Constant Sampling Rate)

Alternatively, the wandering behavior scoring module may generate an abnormality score when the monitored object is wandering within a predetermined area for a predetermined time, as described below.

First, the wandering behavior scoring module 64 defines a minimum bounding box (MBR) of trajectory for each point in a trajectory based on minimums and maximums of x-axis position (xmin, xmax) and y-axis position (ymin, ymax). Next, the wandering behavior scoring module 64 generates two differences and an MBR radius as follows:

xdiff(i)=(xmax−xmin)²

ydiff(i)=(ymax−ymin)²

radius(i)=\sqrt{xdiff(i)+ydiff(i)}

The wandering behavior scoring module 64 then determines the average speed of the monitored object (ExpectedSpeed(i, j), j=1, 2, . . . , k) based on k samples of instantaneous velocity. The k instantaneous velocities may be sampled at equal 1/k intervals during a sampling period.

Next, the wandering behavior scoring module 64 determines an expected minimum wandering time (ExpectedMinWanderingTime) based on a piecewise function as follows:

$$ExpectedMinWanderingTime = {\sum }_{j = 1}^{k} \frac{radius ( i ) / k}{ExpectedSpeed ( i , j )} ,$$

where k may be configurable. For example, if k is equal to 8, the expected minimum wandering time is estimated by dividing the trajectory into 8 segments.

The wandering behavior scoring module 64 then generates a confidence factor (CF) based on a silhouette size of the monitored object (numPixels) and a silhouette size model that tracks an average silhouette size of the monitored object avgPixels and a standard deviation (stdPixels). A corrected silhouette size z(i) may be generated as follows:

$$z ( i ) = \frac{\vert numPixels - avgPixels \vert}{stdPixels} .$$

Then, the confidence factor CF may be determined based on the corrected silhouette size z(i) as follows:

$$CF ( i ) = \{ \begin{matrix}exp ( - ( z ( i ) - 1 ) ) & if z ( i ) > 1 \\ 1 & otherwise ,\end{matrix}$$

where CF equals one (i.e., full confidence) when z(i) is less than or equal to one. In other words, it indicates the silhouette size (i.e., blob size) is normal since the silhouette size is within a standard deviation of the average silhouette size. Otherwise, CF is reduced based on z(i) to represent a level of abnormality (i.e., confidence diminishes).

The wandering behavior scoring module 64 determines a minimum wandering time (minWanderingTime) based on the average trajectory duration (avgTrajectoryDuration) and its standard deviation of trajectory duration (stdTrajectoryDuration). The minimum wandering time minWanderingTime may be the average trajectory duration avgTrajectoryDuration plus two standard deviations stdTrajectoryDuration (minWanderingTime=avgTrajectoryDuration+2*stdTrajectoryDuration). A score factor (scoreFactor(i)) is defined to describe this purpose, as shown below. If trajectory time is less than average trajectory time, scoreFactor(i) is zero, otherwise:

$$scoreFactor ( i ) = 1 - exp ( - \frac{trajectoryTime ( i ) - avgTrajectoryTime}{stdTrajectoryTime} ) .$$

More specifically, the score factor is monotone and proportional to the trajectory time. For example, when the trajectory duration is more than two standard deviations stdTrajectoryDuration beyond the average trajectory duration avgTrajectoryDuration, the score factor is close to 1. Alternatively, for example, when the trajectory duration is less than two standard deviations stdTrajectoryDuration beyond the average trajectory duration avgTrajectoryDuration, the score factor is decreased exponentially.

Finally, the wandering behavior scoring module 64 generates an abnormality score based on the following:

$$Score = 1 - exp ( \begin{matrix}- \frac{TrajectoryTime ( i )}{ExpectoryMinWanderingTime} * \\ CF ( i ) * scoreFactor ( i )\end{matrix} )$$

where TrajectoryTime(i) corresponds to a determined time that the monitored object was within the wandering area. Score equals 0 when TrajectoryTime(i) is less than or equal to the minimum wandering time minWanderingTime.

### Speeding Behavior Scoring

The speeding behavior scoring module 66 processes metadata corresponding to a monitored object to determine whether the monitored object is traveling at a normal (i.e., safe) speed defined by the normal motion models.

The speeding behavior scoring module 66 retrieves the normal motion models and the filtered metadata from the filtering module 60 (or a corresponding datastore). The speeding behavior scoring module 66 generates an abnormality score when the monitored object is traveling at a speed that exceeds a predetermined speed threshold as described below.

First, the speeding behavior scoring module 66 determines an instantaneous speed of the monitored object and a current direction of the monitored object based on a current position and time (x(i), y(i), ts(i)) and a previous position and time (x(i−w), y(i−w), ts(i−w)). The speeds may be determined as follows:

$$Vx = \frac{x ( i ) - x ( i - w )}{ts ( i ) - ts ( i - w )}$$

$$Vy = \frac{y ( i ) - y ( i - w )}{ts ( i ) - ts ( i - w )} ,$$

where the previous position (i−w) is determined by a given minimal displacement minDis such that the displacement from (i−w) to (i) is greater than minDis, but the displacement from (i−w+1) to (i) is less than or equal to minDis. The minimal displacement minDis may also be configurable. For example, minDis may be at least the object size estimated by external tracking algorithms.

Next, the speeding behavior scoring module 66 determines K closest directions to the determined direction of the monitored object. K may be predetermined or may be set by an operator via the GUI 22. For example K may be three, as shown in FIG. 7B and previously described.

The speeding behavior scoring module 66 generates an abnormal behavior score based on the speed of the monitored object and the K average speeds corresponding to the closest directions to the determined direction of the monitored object. However, if no velocity information exists in a particular direction (i.e., see FIG. 4), a factor (isWeighted(i)) for the particular direction may be set to zero. Otherwise, if velocity information exists, the factor isWeighted(i) may be set to one (i.e., information exists) and the speeding behavior scoring module 66 may generate a distance factor d(i) for remaining ones of the K closest directions. Weighting a plurality of directions increases the accuracy and robustness of speeding behavior detection. In other words, without weighting, velocity information may not be available and thus an error may result.

The speeding behavior scoring module 66 generates the distance factors d(i) based on a difference (θᵢ) between the directional angle of the monitored object and the directional angle of the corresponding one of the K closest directions. For example, d(i) may equal cos(θᵢ). The speeding behavior scoring module 66 then generates weight factors w(i) for each of the K closest directions. If K=3 the weight factors w(i) may be generated as follows:

w(1)=isWeighted(1)*d(2)*d(3)

w(2)=d(1)*isWeighted(2)*d(3).

w(3)=d(1)*d(2)*isWeighted(3)

Furthermore, a total weight factor (totalWeight) is generated based on the weight factors w(i), and may be used to normalize weights. For example, the total weight factor totalWeight may be a sum of the weight factors w(i) (e.g., totalWeight=w(1)+w(2)+w(3)). The speeding behavior scoring module 66 then generates an estimated average velocity (vel_hat) and an estimated standard deviation (std_hat) corresponding to the current direction of the monitored object. If the total weight totalWeight equals 0, both vel_hat and std_hat may be set to zero. Otherwise, vel_hat and std_hat may be generated as follows:

$$vel\_hat = \frac{[ w ( 1 ) * avgVel ( 1 ) + w ( 2 ) * avgVel ( 2 ) + w ( 3 ) * avgVel ( 3 ) ]}{totalWeight}$$

$$std\_hat = \frac{[ w ( 1 ) * avgStd ( 1 ) + w ( 2 ) * avgStd ( 2 ) + w ( 3 ) * avgStd ( 3 ) ]}{totalWeight}$$

where avgVel(i) corresponds to average velocities of the K closest directions and avgStd(i) corresponds to average standard deviations of the K closest directions. Normalized speed through vel_hat will calibrate the velocity in the far view and near view field in the field of view of a camera. Based on the normalized speed, scores generated by the speeding behavior scoring module 66 may be at the same level when objects have same velocities but are in different fields in the field of view of one of the sensing devices 12a-12n.

The speeding behavior scoring module 66 then generates raw abnormality scores based on the average speed at the current direction vel_hat as follows:

$$score\_Raw = ( 1 - exp ( \begin{matrix}- lamda * \\ \frac{\sqrt{{V}_{x}^{2} + {V}_{y}^{2}}}{vel\_hat}\end{matrix} ) ) * ( 1 - randomFactor ) .$$

where lamda may be configurable based on how fast the object moves to be detected as abnormal speeding. For example, if three times of average speed is significant, lamda may be defined as ⅓. The randomness (randomFactor) is estimated based on the estimated measurement error and change in motion direction of the monitored object. For example, the randomness may be generated as follows:

$$randomFactor = max ( 0 , 1 - \frac{\sqrt{{( x ( i ) - x ( i - w ) )}^{2} + {( y ( i ) - y ( i - w ) )}^{2}}}{{\sum }_{k = i - w}^{i} {ɛ}_{k}} ) .$$

where, εₖ is the estimated measurement error predicted by the Kalman filter.

The speeding behavior scoring module 66 then generates the abnormality score based on the raw abnormality scores. The speeding behavior scoring module 66 may generate the abnormality score based on a median of the raw abnormality scores for a predetermined time period. The predetermined time period (i.e., the time window) may be k seconds, where k is defined as follows:

$$k = max ( 0.5 , ⌊ \frac{\frac{\sqrt{{colSize}^{2} + {rowSize}^{2}}}{\sqrt{{Vx}^{2} + {Vy}^{2}}}}{8} ⌋ ,$$

where colSize and rowSize correspond to a stored number of samples. For example, K=min(k,2) may indicate that a moving time window varies from 0.5 to 2 seconds.

Dynamic adjustment (i.e., control) of the time window may reduce errors due to objects in a far field of one of the sensing devices 12a-12n. More specifically, objects in the far field may appear to be moving at lower velocities than corresponding actual velocities. Therefore, the time window may be adjusted to counteract the effects of the far field. Alternatively, the normalized velocity corresponding to the far field may counteract the effects of the far field.

In another feature of the invention, the behavior assessment module 36 may generate a map including abnormal behavior scores of objects to improve a severity level assignment for particular sensing devices 12a-12n and particular abnormal behaviors. For example only, the map may be referred to as an adaptive false alarm reduction map (AFARM). Thus, the surveillance system 10 may prioritize abnormal events based on their severity without overwhelming the security operators with an excessive number of alarms to attend to.

The behavior assessment module 36 collects the abnormality scores of objects for each abnormal behavior type for score normalization. For example, the following parameters may be determined:

AFARM[ ].aveScore=Average Abnormal Behavior Score of object

AFARM[ ].stdScore=Standard Deviation of Abnormal Behavior Scores

AFARM[ ].n=Number of Samples

AFARM[ ].minScore=Minimum Abnormal Score Value

The AFARM for each abnormal behavior detector may be generated as follows. First, the average abnormal behavior score (aveScore) is set to a minimal value (minScore). For example, MinScore may be 0.75. Next, the number of trajectory samples is set to a given number (n). For example, n may be 100.

Additionally, after each object trajectory is processed, the abnormal behavior type (J) in the AFARM is updated as follows for a given abnormal behavior score of S:

newSample = AFARM[J].minScore;
if S > AFARM[j].aveScore:
newSample = S;
end,

where

$$AFARM [ J ] . aveScore = \frac{AFARM [ J ] . aveScore \times ( AFARM [ J ] . n - 1 ) + newSample}{AFARM [ J ] . n} .$$

Therefore, the average score (aveScore) may remain above the given minimal score. Based on the AFARM, the surveillance system 10 may spread scores out and greatly distinguish normal and abnormal behavior based on the normalized score.

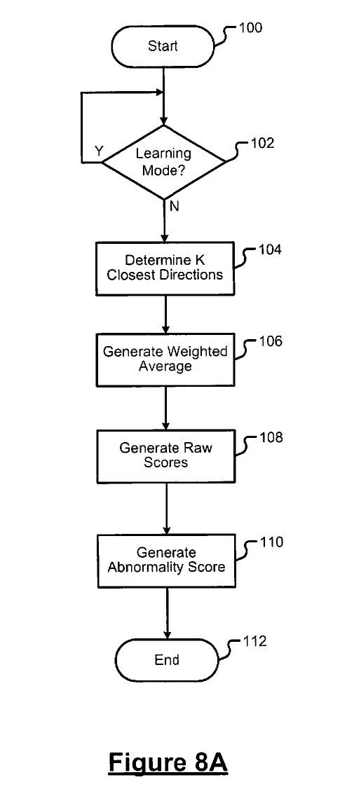

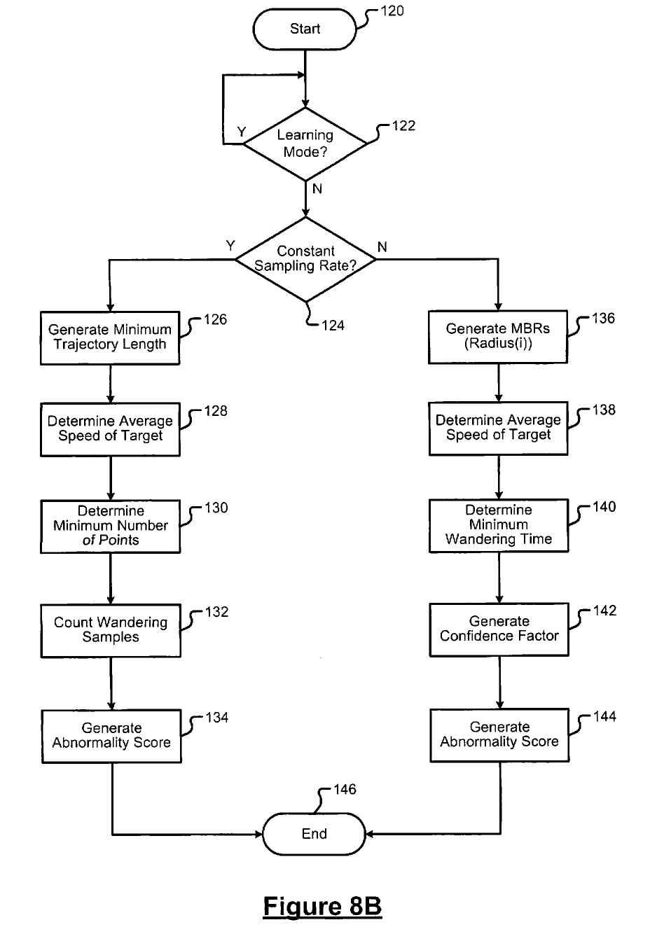

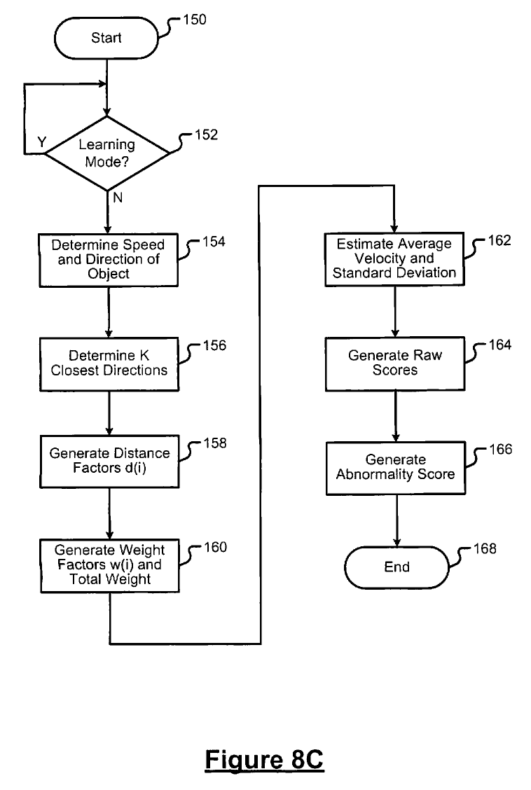

Referring now to FIG. 8A, a method for generating a wrong direction abnormality score begins in step 100. In step 102, the abnormal behavior detection module 20 determines whether it is in learning mode. If yes, control may return to step 102. If no, control may proceed to step 104.

In step 104, the abnormal behavior detection module 20 determines K closest directions to the direction of the monitored object. For example only, the K closest directions may be the directions with the smallest differences between their directional angle and the directional angle of the monitored object.

In step 106, the abnormal behavior detection module 20 generates a weighted average of the K closest directions. More specifically, the abnormal behavior detection module 20 generates a likelihood based on K likelihoods and K angles corresponding to the K closest directions.

In step 108, the abnormal behavior detection module 20 generates raw scores based on the weighted average and the K corresponding likelihoods. In step 110, the abnormal behavior detection module 20 generates an abnormality score based on the raw scores. For example only, the abnormal behavior detection module 20 may generate the abnormality score based on an average of the raw scores over a predetermined time period. Control may then end in step 112.

Referring now to FIG. 8B, a method for generating a wandering abnormality score begins in step 120. In step 122, the abnormal behavior detection module 20 determines whether it is in learning mode. If yes, control may return to step 122. If no, control may proceed to step 124.

In step 124, the abnormal behavior detection module 20 determines whether it is operating with a constant sampling rate. If yes, control may proceed to step 126. If no, control may proceed to step 136.

In step 126, the abnormal behavior detection module 20 generates a minimum trajectory length corresponding to a wandering area. In step 128, the abnormal behavior detection module 20 may determine an average speed of the monitored object. In step 130, the abnormal behavior detection module 20 may determine a minimum number of points within the wandering area corresponding to wandering behavior.

In step 132, the abnormal behavior detection module 20 counts a number of samples that the monitored object is wandering. In other words, the abnormal behavior detection module 20 may count a number of samples that the monitored object is within the wandering area. In step 134, the abnormal behavior detection module 20 may generate an abnormality score based on the counted number of samples. Control may then end in step 146.

In step 136, the abnormal behavior detection module 20 generates minimum bounding boxes (MBRs), also referred to by radius(i), corresponding to a wandering area. In step 138, the abnormal behavior detection module 20 may determine an average speed of the monitored object.

In step 140, the abnormal behavior detection module 20 determines a minimum wandering time. For example only, the minimum wandering time may correspond to a period of time that the monitored object may be within a corresponding MBR to be classified as wandering behavior.

In step 142, the abnormal behavior detection module 20 generates a confidence factor CF based on average and expected silhouette size (i.e., pixel size) of the monitored object. In step 144, the abnormal behavior detection module 20 may generate an abnormality score based on the minimum wandering time, a trajectory time corresponding to the monitored object, and the confidence factor. Control may then end in step 146.

Referring now to FIG. 8C, a method for generating a speeding abnormality score begins in step 150. In step 152, the abnormal behavior detection module 20 determines whether it is operating in learning mode. If yes, control may return to step 152. If no, control may proceed to step 154.

In step 154, the abnormal behavior detection module 20 determines a speed and a direction of the monitored object. In step 156, the abnormal behavior detection module 20 may determine K closest directions to the monitored object. For example only, the K closest directions may be the directions with the smallest differences between their directional angle and the directional angle of the monitored object.

In step 158, the abnormal behavior detection module 20 generates distance factors d(i) for each of the K closest directions. For example only, a distance factor d(i) may be zero when no velocity information exists for the corresponding one of the K closest directions. For example only, a distance factor d(i) may be based on the difference between a corresponding directional angle and the directional angle of the monitored object.

In step 160, the abnormal behavior detection module 20 generates weight factors w(i) based on the distance factors d(i). In step 162, the abnormal behavior detection module 20 generates a total weight factor. For example only, the total weight factor may be a sum of the weight factors w(i).

In step 162, the abnormal behavior detection module 20 estimates an average velocity and standard deviation of an object at the current position. In step 164, the abnormal behavior detection module 20 generates raw scores based on the average velocity of the monitored object and the average velocity of an object at the current position.

In step 166, the abnormal behavior detection module 20 generates an abnormality score based on the raw scores. For example only, the abnormal behavior detection module 20 may generate the abnormality score based on a median of the raw scores over a predetermined time period. Control may then end in step 168.

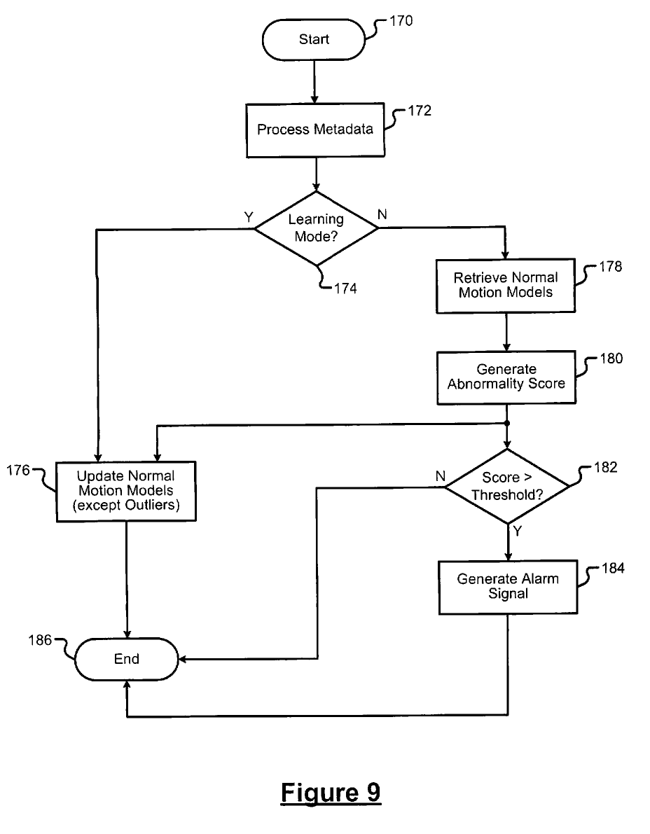

Referring now to FIG. 9, a method for operating the surveillance system 10 begins in step 170. In step 172, the abnormal behavior detection module 20 processes metadata based on image data received from sensing devices 12a-12n.

In step 174, the abnormal behavior detection module 20 determines whether it is operating in learning mode. If yes, control may proceed to step 176. If no, control may proceed to step 178. In step 176, the abnormal behavior detection module 20 updates (or generates) normal motion models based on the processed metadata. Control may then end in step 186.

In step 178, the abnormal behavior detection module 20 retrieves normal motion models from the normal model datastore 28. In step 180, the abnormal behavior detection module 180 generates an abnormality score corresponding to a monitored object. For example only, the abnormality score may be based on one or more normal motion models and/or pre-processed metadata corresponding to the monitored object. Control may then proceed to both steps 176 and 182. In other words, the abnormal behavior detection module 20 may update the normal motion models in step 176 based on the generated abnormality scores.

In step 182, the abnormal behavior detection module 20 compares the abnormality score to a predetermined abnormality score threshold. If the abnormality score is greater than the predetermined abnormality score threshold, control may proceed to step 184. Otherwise, control may proceed to step 186 and control may end.

In step 184, the abnormal behavior detection module 20 generates an alarm signal corresponding to the abnormal behavior of the monitored object. For example only, the alarm signal may be sent to at least one of the GUI 22, A/V alarms 24, and a recording storage module 26. Control may then end in step 186.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A surveillance system that improves accuracy and robustness of abnormal behavior detection of a monitored object traversing a space comprising:
a model building processing circuit receiving attributes of the object and building at least one normal motion model;
a behavior assessment processing circuit receiving the at least one normal motion model and scoring at least one of a wrong direction behavior, a wandering behavior and a speeding behavior to thereby define a score; and
an alarm generation processing circuit generating an alarm according to the score.

2. The surveillance system of claim 1, wherein the behavior assessment processing circuit comprises:
a wrong direction behavior scoring processing circuit generating the score of wrong direction behavior;
a wandering behavior scoring processing circuit generating the score of wandering behavior; and
a speeding behavior scoring processing circuit generating the score of speeding behavior.

3. The surveillance system of claim 1, wherein the model building processing circuit receives the attributes of the object from at least one sensing device.

4. The surveillance system of claim 3, wherein the sensing device is a video camera.

5. The surveillance system of claim 1, wherein the attributes of the object comprise at least one of a position of the object, a direction of movement of the object and a velocity of the object.

6. A surveillance method that improves accuracy and robustness of abnormal behavior detection of a monitored object traversing a space comprising:
using a processing circuit to build a model by receiving attributes of the object and building at least one normal motion model;
using a processing circuit to receive the at least one normal motion model and to score at least one of a wrong direction behavior, a wandering behavior and a speeding behavior to thereby define a score; and
using a processing circuit to generate an alarm according to the score.

7. The method of claim 6, further comprising:
using a processing circuit to generate the score of wrong direction behavior;
using a processing circuit to generate the score of wandering behavior; and
using a processing circuit to generate the score of speeding behavior.

8. The method of claim 6, further comprising:
using a processing circuit to receive the attributes of the object from at least one sensing device.

9. The method of claim 8, wherein the sensing device is a video camera.

10. The method of claim 6, wherein the attributes of the object comprise at least one of a position of the object, a direction of movement of the object and a velocity of the object.

11. A computer program product comprising a non-transitory computer-readable medium having a computer-readable program code embodied therein, said computer-readable program code adapted to be executed by a processor to implement a surveillance method, said method comprising:
building a model by receiving attributes of an object and building at least one normal motion model;
receiving the at least one normal motion model and scoring at least one of a wrong direction behavior, a wandering behavior and a speeding behavior to thereby define a score; and
generating an alarm according to the score.

12. The computer program product of claim 11, wherein the computer-readable program code is further adapted to be executed by a processor:
to generate the score of wrong direction behavior,
to generate the score of wandering behavior, and
to generate the score of speeding behavior.

13. The computer program product of claim 11, wherein the computer-readable program code is further adapted to be executed by a processor to receive the attributes of the object from at least one sensing device.

14. The computer program product of claim 11, wherein the computer-readable program code is further adapted to be executed by a processor, wherein the sensing device is a video camera.

15. The computer program product of claim 11, wherein the computer-readable program code is further adapted to be executed by a processor, wherein the attributes of the object comprise at least one of a position of the object, a direction of movement of the object and a velocity of the object.
